(19) United States
(12) Patent Application Publication
(10) Pub. No.: US 2019/0163725 A1
(43) Pub. Date: May 30, 2019

(54) DOCUMENT CONTENT RESIZING

(71) Applicants: Hewlett-Packard Development Company, L.P., Houston, TX (US); INSTITUTO DE PESQUISAS ELDORADO, Campinas (BR)

(72) Inventors: Dalmir Antonio da Silva, Vancouver, WA (US); Fabio Santos Nallem, Sant Cugat del Valles (ES); Lucas Dalmedico Gessoni, Campinas (BR); Ronaldo Canesqui, Campinas (BR); Peter Pennings, Campinas (BR); Patricia Teixeira, Campinas (BR); Natalia Campagnoli Franchi, Campinas (BR); Luiz Rafael de Souza, Campinas (BR); Julio Cesar Soares do Nascimento, Campinas (BR); Fabio Fernando de Lima Pereira, Campinas (BR); Douglas Cesar Pampu, Campinas (BR); Danilo Monteiro de Souza, Campinas (BR); Andre Luiz Teodoro, Campinas (BR); Adilson Dutra Teixeira Filho, Campinas (BR)

(21) Appl. No.: 16/097,577

(22) PCT Filed: Jul. 28, 2016
(86) PCT No.: PCT/US2016/044539

§ 371 Date: Oct. 29, 2018

(51) Int. Cl. G06F 17/21

(52) U.S. Cl. CPC G06F 17/212

(57) ABSTRACT

Examples disclosed herein relate to content resizing. An example method can include identifying an input content boundary of content in an input document file based on internal structure data of the input document file. The example method may also include storing a received user input of preferences for a new size and a detected rotation for an output document file. The example method may also include generating a calculated ratio between an input document display size and an output document display size. In an example, the method may include mapping a coordinate system to each point of the input content boundary. In an example, the method may also include drawing output content into the output document file by applying the calculated ratio and the detected rotation for the output document file to the mapped coordinate system of the content in the input content boundary.

### BACKGROUND

Text and image documents can be digitally displayed as static images and can also be altered to a variety of sizes. Resizing of images can be resized through direct scaling functions, however, resizing documents can affect a display space and may not adjust the size of the content within the display space. Manual adjustment of content size can often be performed through user adjustment separate from a document resizing step.

### DESCRIPTION OF THE DRAWINGS

Certain exemplary embodiments are described in the following detailed description and in reference to the drawings, in which:

FIG. 1 is a block diagram of an example system for content resizing;

FIG. 2 is a schematic diagram of an example document and content resizing with a content resizer;

FIG. 3 is a flowchart of an example method for resizing content;

FIG. 4 is a block diagram of an example tangible, non-transitory, computer-readable medium including instructions to direct a processor to resize content;

FIG. 5 is a block diagram of an example user interface for content resizing;

FIG. 6 is a schematic diagram comparing the outputs of existing solutions in document resizing and the content resizer presently disclosed; and

FIG. 7 is a schematic diagram comparing the effect of existing resizers and the content resizer presently disclosed.

### DETAILED DESCRIPTION

There are many different sizes of pages that are used to print content, as there are many different sizes and ratios of screens in computing devices like desktop computers, phone, tablet, notebooks and smart TVs. Thus, content generated in a specific size is adapted to other sizes in a multimedia environment, so that it can be properly printed or shown in that particular device or for a particular application, without the content being unusable. In an example, content may be partially visible or not occupying the available space adequately. Content can be contained within fixed-layout flat documents. In one example, these documents can include, for example, portable document format (PDF) documents for sharing finished media to be displayed or printed in different devices. Many fixed-layout flat documents, including PDF, can include an inherent capability to adapt their resolution for a target device. Presently, fixed-layout flat documents do not have the capability to change the size and aspect ratio of the content together with the size and aspect ratio of the page. Additionally, although fixed-layout flat documents may have the capability to have structural elements like paragraphs that describe how to group content, use of the document's structural elements for grouping content may not may, in some cases, not be used. Presently, the absence of these markers in most fixed-layout flat documents can make it difficult to group or separate content to occupy a number of different sizes of pages.

In the present application, media can be resized for different aspect ratios with a fixed-layout flat document without making the content partially visible or having a content sized so large that it may not occupy the space available. In an example, the present disclosure shows a method that permits the content of a PDF to be resized and aligned to the proper margins even when a page of this document may be resized and the page's aspect ratios changed. The disclosed method allows non-default rotation and orientation of content within the fixed-layout flat documents. The present disclosure shows, in part, a technique to ensure that any fixed-layout flat document, such as a PDF, may be resized in such a way that the contents of the page, after the resize operation is done, do not become too big or too small for the newly sized page. Presently, resizing of fixed layout flat documents can result in content being cut out as the content may not be resized correctly, and instead may lay outside of the output page. Alternatively, previous methods may adjust pages such that the majority of the output page may be being blank space with content covering a small portion compared to the content's coverage of the previous version of the page.

The present method further allows align of the content in the new resized page without user input for manual adjustments in coordinates. In an example, manual input of coordinates include specific distances such as, translate 10 inches to the right and 5 inches up. In the present disclosure, alignment may be chosen with intuitive natural language, for example, aligning the content to “center” of the page or to the “bottom left corner”. Previously, the user may have manually calculated how much to translate content to align it in the indicated position. In the present disclosure, the resizing of content can with paired with the rotation of fixed-layout flat documents. Rotated fixed-layout flat documents, including PDFs, can include a rotated entry in a page dictionary of the internal structure. Previously, contents including a rotated entry in a page dictionary may not have been properly resized and part of the contents were cut off out of the page, generating an unusable result. In the present disclosure, contents can be properly rotated and resized upon page resizing. Further, in an example, drawing outside of an original area of the page can be blocked or masked to prevent undesired content from becoming inadvertently visible after the resizing of the document.

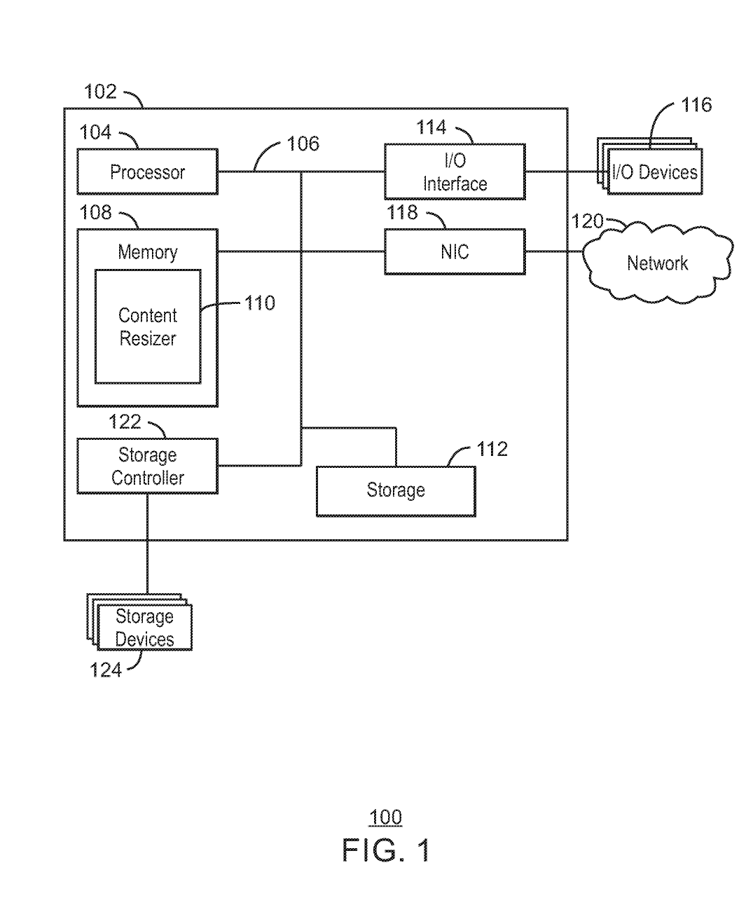

FIG. 1 is a block diagram of an example system for content resizing. The system 100 includes a computing device 102. The computing device can be a mobile phone, a tablet computer, a desktop computer, a business server, a blade server, a storage attached network (SAN), a network attached storage (NAS), and the like. The computing device 102 includes at least one processor 104. The processor can be a single core processor, a multicore processor, a processor cluster, and the like. The processor 104 can be coupled to other units through a bus 106. The bus 106 can include peripheral component interconnect (PCI) or peripheral component interconnect express (PCIe) interconnects, Peripheral Component Interconnect eXtended (PCIx), or any number of other suitable technologies for transmitting information.

The computing device 102 can be linked through the bus 106 to a memory 108. The system memory 108 can include random access memory (RAM), including volatile memory such as static random-access memory (SRAM) and dynamic random-access memory (DRAM). The system memory 108 can also include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. In an example, a memory can be used to implement persistent memory if it can be directly addressed by the processor at a byte or word granularity and has non-volatile properties.

The memory 108 can store a content resizer 110 to resize content inside a fixed-layout flat document. As used herein the fixed layout document may be a document with content that may be displayed in a static arrangement regardless of the device or software used to display the document. The resizing of content can interface with the processor 104 to identify an input content boundary of content in an input document file based on internal structure data of the input document file. In an example, the memory 108 may store a received user input of preferences for a new size and a rotation for an output document file. The processor 104 may also generate a calculated ratio between an input document display size and an output document display size. In an example, the content resizer 110 may interface with the processor 104 to map a coordinate system to each point of the input content boundary. The coordinate system generated can be used by the content resizer 110 and the processor 104 to draw output content into the output document file. In an example, this may occur by applying the calculated ratio and the detected rotation for the output document file to the mapped coordinate system of the content in the input content boundary. In an example, drawing the output content may additionally be based on a received horizontal alignment and vertical alignment. Further, mapping the coordinate system can include setting a point along the input content boundary as an origin of the coordinate system. The content resizer 110 may also create a masked area equal to the area of the input content resized by the calculated ratio and exclude any drawing outside the masked area on the output document.

The computing device 102 can include a tangible, non-transitory, computer-readable storage media, such as a storage 112 for the long-term storage of data, including the operating system programs and user file data. The processor 104 may be coupled through the bus 106 to an input output (I/O) interface 114. The I/O interface 114 may be coupled to any suitable type of I/O devices 116, including input devices, such as a mouse, touch screen, keyboard, display, and the like. The I/O devices 116 may also be output devices such as a display monitors. In an example, the user input used by the content resizer 110 may include preferences received at the I/O devices 116 that may include a horizontal alignment and a vertical alignment to be used for drawing output content within the output document file.

The computing device 102 can also include a network interface controller (NIC) 118, for connecting the computing device 102 to a network 120. In some examples, the network 120 can be an enterprise server network, a storage area network (SAN), a local area network (LAN), a wide-area network (WAN), or the Internet, for example.

The processor 104 can also be coupled to a storage controller 122, which may be coupled to one or more storage devices 124, such as a storage disk, a solid state drive, an array of storage disks, or a network attached storage appliance, among others. The presence of the storage devices 124 may allow the computing device 102 to function as a storage attached network (SAN) on the network.

The storage device 112 can include local storage in a hard disk or other non-volatile storage elements. While generally system information may be stored on the storage device 112, in this computing device 102, the program data can be stored in the memory 108 as indicated here and discussed further in FIG. 1B.

It is to be understood that the block diagram of FIG. 1 is not intended to indicate that the computing device 102 is to include all of the components shown in FIG. 1. Rather, the computing device 102 can include fewer or additional components not illustrated in FIG. 1. For example, the content resizer 110 can be implemented as stored software in the storage 112 that can be initialized and loaded into memory 108 upon the booting of the system 100. In an example, if the computing device 102 is a server or blade server, the storage controller 122 and external storage devices 124 may not be present. In an example, the computing device 102 can include additional processors, memory controller devices, network interfaces, etc.

As shown in FIG. 1, the content resizer 110 allows resizing the content of a fixed-layout flat document together with the page containing that content in a way that ensures that no part of the original content will be cut out of the page and lost. Further, the content resizer 110 ensures that no objects out of the area of the original page will become visible through masking that prevents extraneous drawing on the output file. Further, the content resizer 110 ensures that the content may be resized to occupy as much space as possible while, if so indicated, still maintaining its aspect ratio and not leaving wasted space. The content resizer 110 enables a user using the system 100 to change the content aspect ratio to stretch it to occupy the entire resized page even if the fixed-layout flat document may be rotated. Further, the content-resizer allows user input to be received as natural language terms which can be translated into how the content resizer 110 may align the content in the resized page.

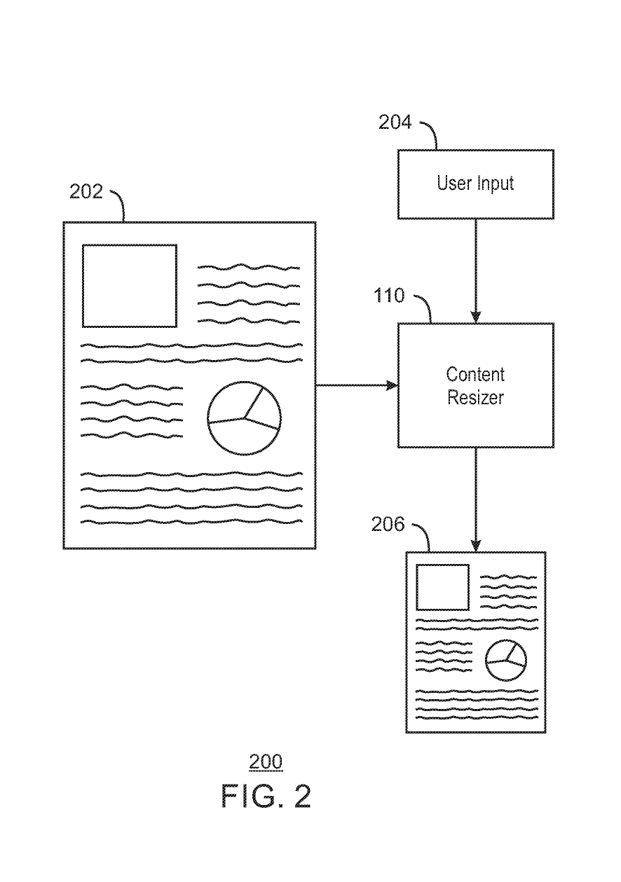

FIG. 2 is a schematic diagram of an example document and content resizing 200 with a content resizer. Like numbered items are as described in FIG. 1.

An input document file 202 can include content within an input content boundary. The content can include text, images, or other suitable input for fixed-layout flat documents. A user may then provide user input 204 to specify a width and height for the page and the indicated horizontal and vertical alignment. Alignments can include any combination of left, right or center as well as bottom, top or center. These alignment designations may be made by a user through the natural language options listed rather than technical definitions of exact pixel requests—thus allowing a user to avoid making calculations for alignment values.

Within the content resizer 110, the input document file page can be resized to the width and height designated by the user input 204. During the resizing of the width and height, the contents may be scaled and aligned as specified to fit the resized page. A user may also choose if the content should maintain its aspect ratio when resized or if the content instead stretches to occupy the whole resized page, in effect changing the aspect ratio of the page and its content.

Upon input to the content resizer 110, the input document file may be found to include boundaries or boxes in the content resize. In an example, the content resizer 110 may discover which, if any, box may be considered to define the boundaries of the printed page. In an example, if a crop box is present in the internal structure of the document, this crop box may be chosen as the boundaries of the printed page. If no box or boundary is found in the input document file, a default media box can be chosen instead.

In some examples, the internal structure of the document along with user input 204 can include an indication that the fixed-format flat document may be a rotated entry. The internal structure of the document may also reveal by a value of degrees how much the document may be rotated. In an example, if the document has rotated 90 degrees, 270 degrees, or any equivalent rotation, the values for the indicated width and height of an output document file can be inverted. In an example, the value for the width indicated by a user can be assigned to the output indicated height and vice versa.

During conversion in the content resizer 110, a user input 204 can indicate a width referred to here as “indicated size [X]” where ‘X’ can refer to the horizontal coordinate axis. The user input 204 can also indicate a height referred to here as “indicated size [Y]” where ‘Y’ refers to the vertical coordinate axis.

The content resizer 110 can assign a new value to the media and crop boxes identified. In an example, this assignment may allow these crop boxes or media boxes to have the same size with their left bottom corner at the origin of a to be assigned coordinate system. For example, the value assigned could include the following: [0,0, indicated width, indicated height].

Using both the initial size of the media or crop boxes with the user indicated sizes, a ratio to resize each coordinate can be calculated. These ratios can include a ratio [X] and a ratio [Y]. In an example where the aspect ratio may be maintained then a simple ratio calculation could a post script expression such as “Ratio [X/Y]=indicated size [X/Y]/old box size [X/Y]”. In an example, if the aspect ratio is not to be maintained, then ratio X and Y can be the same, and the ratio value can be calculated as the following “Ratio=indicated size [X]/old box size [X]”, where if old box size [Y]*ratio>indicated size [Y] then ratio=indicated size [Y]/old box size [Y].

Based on the user input 204, the indicated horizontal and vertical alignment values may be modified in respect to the rotated page. For example, if the user input 204 indicates a selection of a left alignment with a page rotated 90 degrees, the combination of these two operations could result in an output where the alignment may be tied to bottom alignment relative to the output document file 206. In another example, if the user input 204 chose a top alignment with the output page to be rotated 90 degrees, the end result may be a left alignment.

A user input 204 can indicate a translation for the content in the horizontal and vertical axis. These values may be expressed to the content resizer 110 as [translate [X] and translate [Y]]. These translations can include the above discussed modified indicated alignments. For example, if the modified indicated horizontal alignment is “right” then a translation operation could be expressed as “Translate [X]=(indicated size [X]−ratio [X]*old box size [X])/ratio [X]”. If a indicated alignment is “left” then a translation operation could be expressed as “Translate [X]=0”. In the case of a “center” alignment, then a translation operation could be “Translate [X]=(indicated size [X]−ratio [X]*old box size [X])/2)/ratio [X]”.

The indicated translations can also take into account indicated vertical alignments. For example, if the indicated alignment is “top” then a translation operation could be “Translate [Y]=(indicated size [Y]−ratio [Y]*old box size [Y]))/ratio [Y]”. If the indicated alignment is “bottom” then a translation operation could be “[Y]=0”. If the indicated alignment is “center” then a translation operation could be “Translate [Y]=(indicated size [Y]−ratio [Y]*old box size [Y])/2)/ratio [Y]”.

Aside from the media or crop boxes, additional values can be assigned to any other yet unmodified boxes of content so that the page can be translated by the calculated translate [X/Y] values and resized by the ratio [X/Y] values with respect to each initial anchor point established between the boxes, the coordinate system, and the modification based on the user input 204.

Once calculated and mapped, a drawing operations can be utilized for creating the output document file content using the output document file 206 syntax. In an example, the fixed-format flat document can include syntax for drawing operations. If the fixed-format flat document is a PDF, the PDF specification can provide drawing syntax for the drawing of the output document file 206.

Depending on the document type, the drawing syntax operations may be added to the beginning of a page content stream. For example, the following three expressions provide an example of operator and values used for a page content stream. The following exemplary expressions are written in postscript language and run on postscript interpreters including PDF Readers and other such readers that can convert postscript to rendering things to the screen or paper. An example of a post script expression may be “ratio_x 0 0 ratio_y 0 0 cm”. This expression can be interpreted by a document reader to resize the coordinate system to the calculated ratios for the horizontal and vertical axes represented here as ratio_x and ratio_y.

An example of a post script expression may be “1 0 0 1 (−1)*old_box_position_x (−1)*old_box_position_y cm”. This expression can be interpreted by a document reader to translate the coordinate system to a position that considers the old position and a previous resize command so that, at the end, the origin of the coordinate system may be visually at the same place as before. For example, this expression can be used to re-center the coordinate system.

An example of a post script expression may be “1 0 0 1 translate_x translate_y cm”. This expression can be interpreted by a document reader to translate the coordinate system to the calculated X and Y position relative newly resized and re-centered coordinates so that the positioning of the content respects the boundaries and the desired margins.

During the creation of the output document file 206, the content resizer 110 can create and add to the page content stream an operation to mask the content to the area equivalent to the resized area of the original content. This masking can be used so that if there were content outside of the page area in the input document file 202 that may not have been originally visible, this content can remain unseen in an output document file 206. For example, the following two operations can be used in concert for masking in a PDF document including “old_box_position_x old_box_position_y old_box_size_x old_box_size_y re” as well as the expression “W n”. In these two example expressions, the first expression describes a rectangular area while the second expression “W n” makes the rectangular area expressed previously behave like a mask. In an example, the mask makes it so that only the content inside the area shows. Further, these expressions can also run on a postscript interpreter as discussed in the examples above.

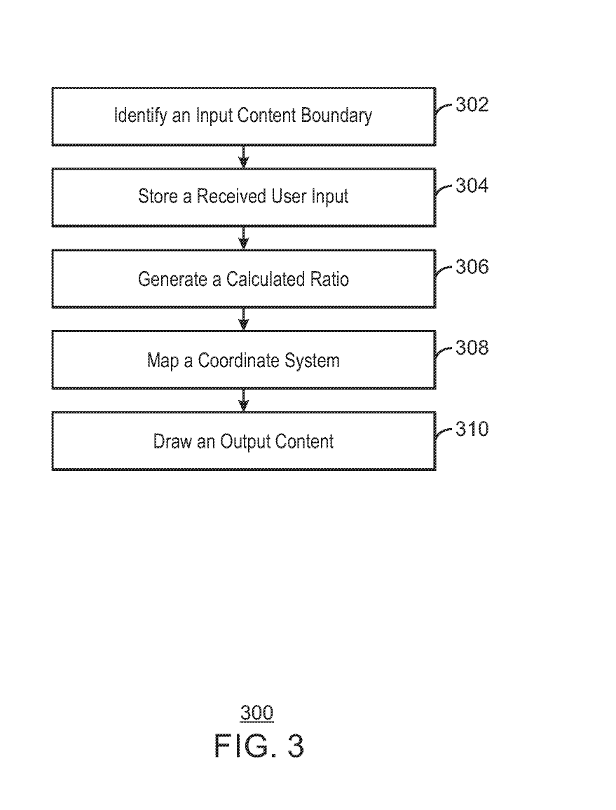

FIG. 3 is a flowchart of an example method for resizing content. The example method begins at block 302, where a content boundary can be identified. The method shown can be implemented on a computing device 102 of FIG. 1.

At block 302, a content boundary of content in an input document file is identified based on internal structure data of the input document file. The content boundary can be a crop box, a media box, or any other formal boundary either designated in the information about the document.

At block 304, a received user input of preferences for a new size and a detected rotation for an output document file can be stored. The user input can also include a horizontal alignment and a vertical alignment to be used for drawing output content within the output document file. The user input may include a translation of content within a relative page location for output in the output document file.

At block 306, a calculated ratio can be generated between an input document display size and an output document display size. This ratio can be calculated for both the horizontal and vertical coordinates separately or together depending on if the user requests that aspect ratio is maintained.

At block 308, a coordinate system can be mapped to each point of the input content boundary. The coordinate system can have an origin set to a specific feature of the identified boundary of the input document file.

At block 310, output content can be drawn into the output document file. In an example, this drawing can be done by applying the calculated ratio taking into account the detected rotation for the output document file to the mapped coordinate system of the content in the input content boundary. In an example, drawing the output content may be based on the horizontal alignment and the vertical alignment.

The method may also include creating a masked area equal to the area of the input content resized by the calculated ratio. In an example this masked area can exclude drawing outside the masked area in an output document file.

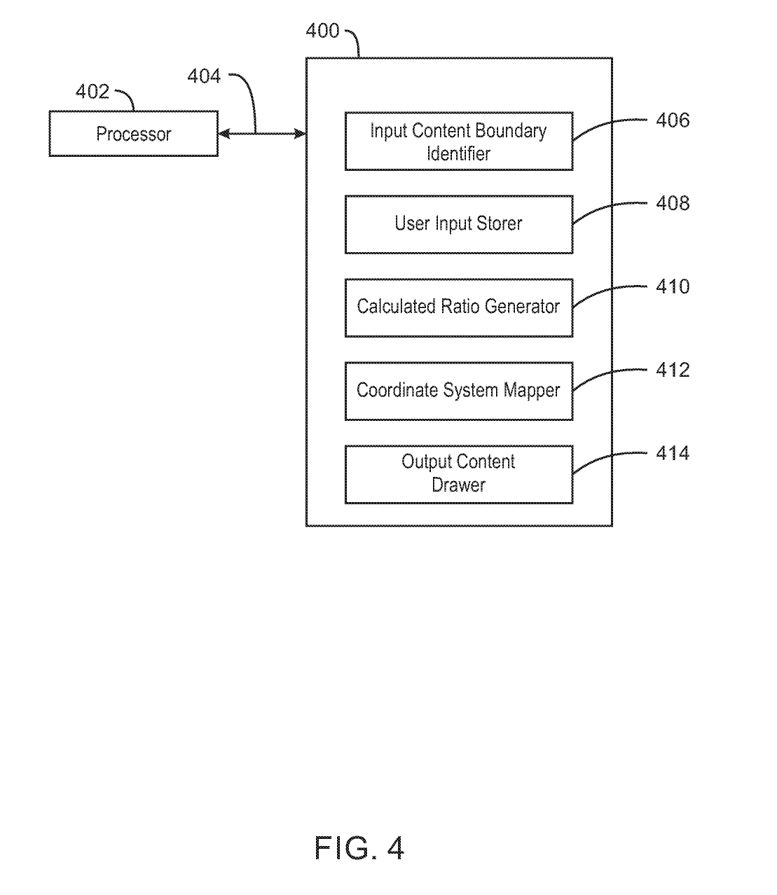

FIG. 4 is a block diagram of an example tangible, non-transitory, computer-readable medium including instructions to direct a processor to resize content. The computer readable medium can include the processor 402 to execute instructions received from the computer-readable medium 400. Instructions can be stored in the computer-readable medium 400. These instructions can direct the processor 402 to configure a device to resize content. Instructions can be communicated over a bus 404 as electrical signals, light signals, or any other suitable means of communication for transmission of data in a similar computing environment.

The computer-readable medium includes an input content boundary identifier 406 to identify an input content boundary of content in an input document file based on internal structure data of the input document file. The computer-readable medium includes a user input storer 408 to store a received user input of preferences for a new size for an output document file. In an example, the user input of preferences additionally comprises a horizontal alignment and a vertical alignment to be used for drawing output content within the output document file. The computer-readable medium includes a calculated ratio generator 410 to generate a calculated ratio between an input document display size and an output document display size. The computer-readable medium includes a coordinate system mapper 412 to map a coordinate system to each point of the input content boundary. The computer-readable medium includes output content drawer 414 to draw output content into the output document file by applying the calculated ratio for the output document file to the mapped coordinate system of the content in the input content boundary.

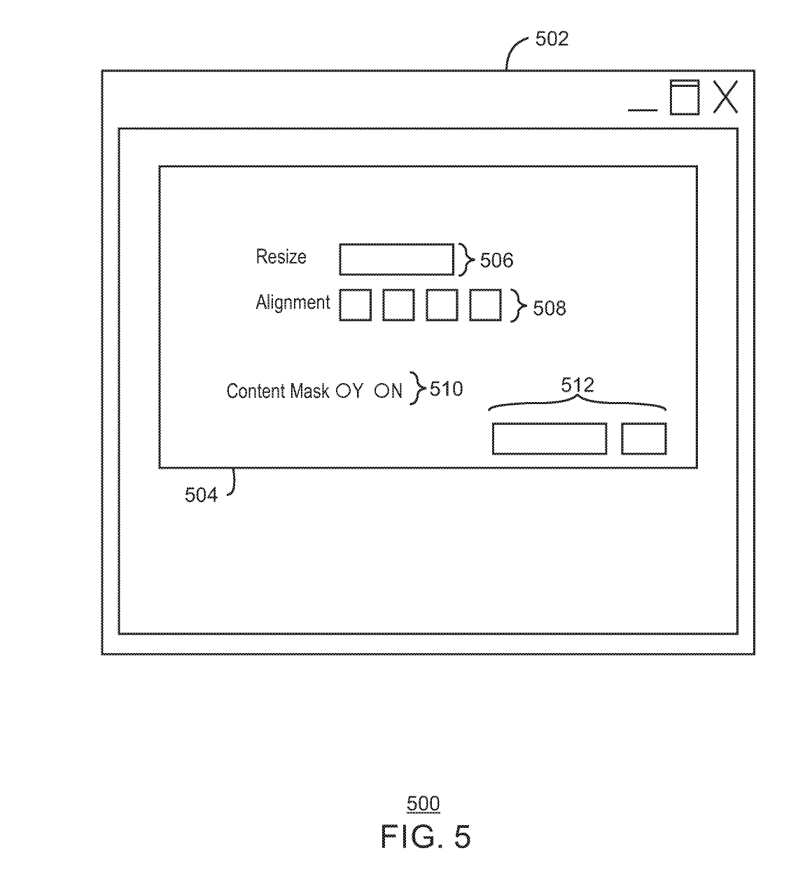

FIG. 5 is a block diagram of an example user interface 500 for content resizing. The example user interface includes a number of options that may be included in a content resizing operation. The shown layout does not represent any limitation, instead providing an example of a means for gathering user input for a number of preferences.

An application window 502 can include the fixed-layout flat document as well as an option to resize the document and its associated content. In an example, another option can be to resize the document to stretch the content to occupy the entire area. When a user selects a particular option to resize the document and its associated content, a panel 504 may appear with input areas to indicate a detected rotation of the document. This detected rotation information can be information retrieved from the state of the file being modified.

The panel 504 may also include an input to indicate the extent of resizing a document through a resizing input area 506. The panel 504 may also provide options for an alignment input area 508 to indicate where the content will be located within the resized document. This can be with natural language options such as “center” or “bottom” or “left” or other suitable descriptors. A content mask option 510 may also be provided on the panel 504 for a content mask that may prevent stray marks from becoming visible in the output document file. The panel 504 can also include action or inaction inputs 512 to either proceed with the resizing of the document and the content, or for cancelling the procedure.

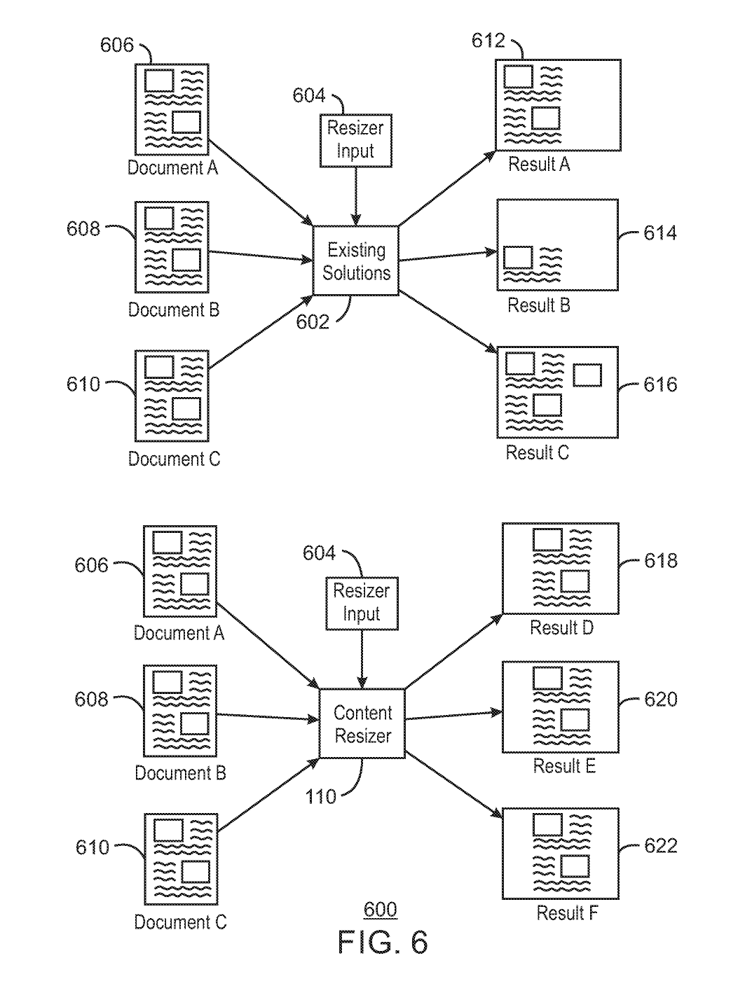

FIG. 6 is a schematic diagram 600 comparing the outputs of existing solutions 602 in document resizing and the content resizer 110 presently disclosed. Like numbered items are as discussed in FIG. 1.

In existing solutions 602, resizer input 604 can be received for adjustments to document A 606, document B 608, or document C 610. However, the results may not account automatically for user input selections for autocentering, document space filling, or content masking. In Result A 612, a default orientation may be left most unless manually adjusted by the user. In Result B 614, content appears in a default corner in the lower bottom left with some content clipped of. In Result C 616, additional content, possibly from another page of the input document C 610, appears improperly in the resulting resized document.

The content resizer 110 herein disclosed can received resizer input 604 for adjustments to document A 606, document B 608, or document C 610. However, by contrast with existing solutions, the content resizer 110 can automatically account for user input selections such as autocentering, document space filling, or content masking. In Result D 618, a centered selection need not be manually adjusted with by the user's adjustments but can be accomplished through preloaded operations in the library of the document reader associated with the content resizer 110. In Result E 620, the resizer input 604 may have been a selection to center the content without clipping. In Result F 624, additional content, possibly from another page of the input document C 610, does not appears the resulting resized document due to the application of a content mask as herein described.

Files may be visually similar or identical but have different internal structures. In an example, the present disclosure provides methods for a consistent result visually, which is something that current methods do not guarantee.

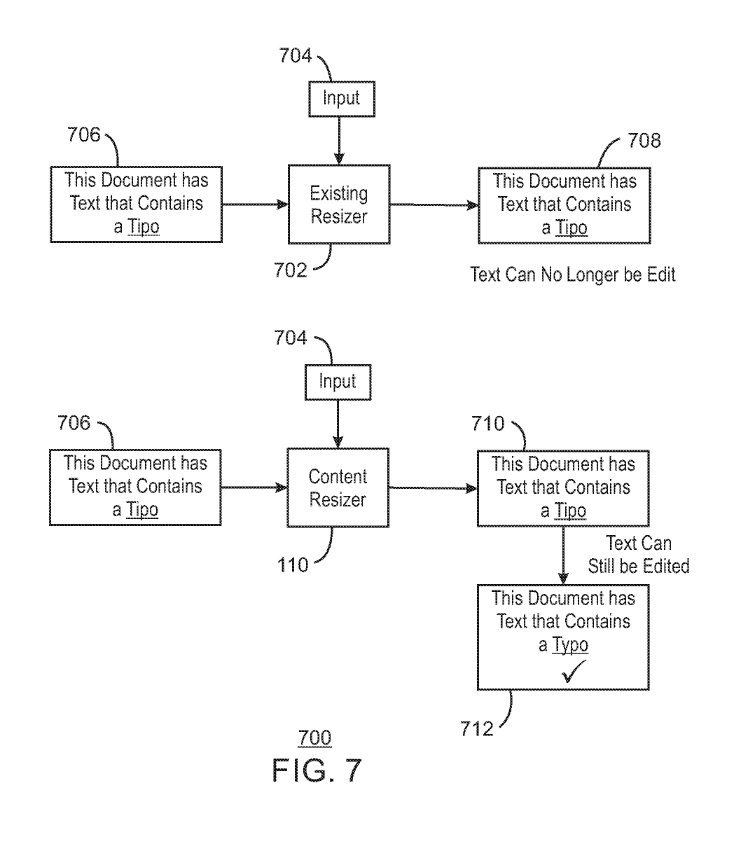

FIG. 7 is a schematic diagram 700 comparing the effect of existing resizers 702 and the content resizer 110 presently disclosed. Like numbered items are as discussed in FIG. 1.

The existing resizers 702 can accept input 704 for adjustments to the documents size, location, aspect ratio, masking, or other similar transformations. Prior to resizing in an existing resizer, the document can be edited. The input typo'd document 706 can be resized but lose an editing function in an output edit-disabled. For example, this can be seen with simple image resizers that simply scale everything in an image without using tools of the internal structure of the document reader to maintain the present elements. Simple image resizers must subsequently proceed through optical text recognition or other similar recoding or redigitizing step to regain an edit function on a resized document.

By contrast, the presently disclosed content resizer 110 preserves an edit function such that the input typo'd document 706 can be resized while maintaining its ability to be edited. The output editable document 710 can then have the text with a typo adjusted so that a final document 712 can be error free and resized in line with the input 704 to the content resizer 110. In an example, this comparison 700 provides an illustration of how the presently disclosed content resizer 110 can preserve a document as a document the entire time.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method for resizing content, comprising:
identifying an input content boundary of content in an input document file based on internal structure data of the input document file;
storing a received user input of preferences for a new size and a detected rotation for an output document file;
generating a calculated ratio between an input document display size and an output document display size;
mapping a coordinate system to each point of the input content boundary; and
drawing output content into the output document file by applying the calculated ratio and the detected rotation for the output document file to the mapped coordinate system of the content in the input content boundary.

2. The method of claim 1, wherein the document file is a portable document format (PDF).

3. The method of claim 1, wherein the user input of preferences additionally comprises a horizontal alignment and a vertical alignment to be used for drawing output content within the output document file.

4. The method of claim 3, wherein drawing the output content is additionally based on the horizontal alignment and the vertical alignment.

5. The method of claim 1, wherein mapping the coordinate system comprises setting a point along the input content boundary as an origin of the coordinate system.

6. The method of claim 1, comprising:
creating a masked area equal to the area of the input content resized by the calculated ratio; and
excluding any drawing outside the masked area.

7. A system for resizing content, comprising:
a processor to identify an input content boundary of content in an input document file based on internal structure data of the input document file;
a memory to store a received user input of preferences for a new size and a detected rotation for an output document file;
the processor to generate a calculated ratio between an input document display size and an output document display size;
the processor to map a coordinate system to each point of the input content boundary; and
the processor to draw output content into the output document file by applying the calculated ratio and the detected rotation for the output document file to the mapped coordinate system of the content in the input content boundary.

8. The system of claim 7, wherein the document file is a portable document format (PDF).

9. The system of claim 7, wherein the user input of preferences additionally comprises a horizontal alignment and a vertical alignment to be used for drawing output content within the output document file.

10. The system of claim 8, wherein drawing the output content is additionally based on the horizontal alignment and the vertical alignment.

11. The system of claim 7, wherein mapping the coordinate system comprises setting a point along the input content boundary as an origin of the coordinate system.

12. The system of claim 7, comprising:
creating a masked area equal to the area of the input content resized by the calculated ratio; and
excluding any drawing outside the masked area.

13. A tangible, non-transitory, computer-readable medium comprising instructions that, when executed by a processor, direct the processor to resize content, the instructions to direct the processor to:
identify an input content boundary of content in an input document file based on internal structure data of the input document file;
store a received user input of preferences for a new size and a detected rotation for an output document file;
generate a calculated ratio between an input document display size and an output document display size;
map a coordinate system to each point of the input content boundary; and
draw output content into the output document file by applying the calculated ratio and the detected rotation for the output document file to the mapped coordinate system of the content in the input content boundary.

14. The computer-readable medium of claim 13, wherein the document file is a portable document format (PDF).

15. The computer-readable medium of claim 13, wherein the user input of preferences additionally comprises a horizontal alignment and a vertical alignment to be used for drawing output content within the output document file.
